(19) United States
(12) Patent Application Publication
(10) Pub. No.: US 2005/0183408 A1
(43) Pub. Date: Aug. 25, 2005

(54) Device for cleaning vehicle exhaust gas

(75) Inventors: Christoph Noller, Konigsbrunn (DE); Peter Kroner, Augsburg (DE); Otto Steinhauser, Neusass (DE)

Correspondence Address: BARNES & THORNBURG, 11 SOUTH MERIDIAN, INDIANAPOLIS, IN, 46204, US

(73) Assignee: Arvin Technologies, Inc.

(21) Appl. No.: 11/061,990

(22) Filed: Feb. 18, 2005

(30) Foreign Application Priority Data
Feb. 20, 2004 (DE) 10 2004 008 415.7

(51) Int. Cl. B01D 46/00

(52) U.S. Cl. 55/523

(57) ABSTRACT

A device for cleaning vehicle exhaust gas, especially a filter for diesel exhaust particulates or a catalytic converter, comprises a filter body including a plurality of individual cuboid bodies through which gas flows. The filter body has, at least in sections, an angular outer contour, as seen in a main direction of flow. The filter body also has an unmachined outer surface at the angular outer contour.

### RELATED APPLICATIONS

This application claims priority to German Patent Application No. 10 2004 008 415, which was filed on Feb. 20, 2004.

### BACKGROUND OF THE INVENTION

The invention relates to a device for cleaning vehicle exhaust gas, especially to a filter for diesel exhaust particulates. The device includes a filter body through which gas flows and which is composed of a plurality of individual cuboid bodies. A housing surrounds the filter body.

Such filter bodies, also called monolith bodies or substrates, are usually composed of extruded, one-piece (monolith) individual bodies made from a material, such as silicon-carbide (SiC), and which are glued to each other. These elongated individual bodies in their commercially available form have a square cross-section. On one end face, the filter bodies have numerous inflow channels that end in blind holes, and which are arranged in a honeycomb-like pattern. Traditionally, the inflow channels have a square cross-section. Adjacent to these inflow channels, are effusion channels that have no direct flow connection to the inflow channels, and which are formed as similar honeycomb-like blind holes having a square cross-section, starting at an opposite end face from the end face with the inflow channels. The exhaust gas flows from one end wall at a side of an inflow region, into the numerous inflow channels, and diffuses through adjoining walls to the effusion channels. Carbon-like exhaust particles, such as soot, are retained in the inflow channels.

Exhaust gas catalytic converters are respectively constructed from coated, one-piece, individual bodies. The filter body composed of individual bodies is machined on the outside. Particularly, the filter body is turned so as to become rounded, which is very expensive owing to the extreme hardness of a ceramic material used to form the filter body. These individual bodies, which are machined, will loose a super proportionally large active filter surface area when compared to internal, unmachined individual bodies. This means that the individual bodies that are machined on their circumference loose considerably more filtering capacity than cross-sectional surface, as seen in relation to the unmachined individual bodies.

It is the object of the invention to provide a device for cleaning vehicle exhaust gas, especially a filter for diesel exhaust particulates, which is less expensive to manufacture, and which has an improved efficiency for cleaning characteristics in relation to the filter cross-section when compared to traditional devices. The present invention is not limited to diesel filters. Rather, the filter bodies can be coated and be part of catalytic converters (e.g. NOₓ-traps).

### SUMMARY OF THE INVENTION

This is achieved by providing a device with a filter body that has, at least in sections, an angular outer contour (as seen in a main direction of flow), and which has an unmachined outer surface at the angular outer contour. With the device according to the invention, the filter body is angular, at least in portions, and preferably has an overall angular outer contour. The overall angular outer contour is achieved by putting together a plurality of individual cuboid bodies. This results in a smaller number of individual bodies being machined on an outer surface. Preferably, there are no individual bodies that are machined on their outer surface, whereby an active filter surface area remains very large. The distribution of carbon-particulate matter and gas within the filter body is thus considerably more uniform than with machined filter bodies, and vice versa a smaller number of individual bodies is required in order to have the same cross-sectional area for the filter body. The uniform charging of the filter body with carbon-particulate matter results in a uniform combustion behavior with non-critical internal temperatures.

A housing surrounds the filter body and preferably has an outer contour that corresponds in shape to the filter body. Preferably, a uniform gap is formed between the filter body and the housing. This gap preferably has a thickness of more than 3 millimeters, so that an air gap arises that acts as a thermal insulation, through which expensive insulation mats may be avoided.

The filter body, as already explained, is unmachined across an entire outer circumference (the outer circumference is seen in the direction of flow and determines the outer contour). Thus, the expense for machining filter bodies can be eliminated.

According to the preferred embodiment, the filter body has an elongated cross-section, as seen in the main direction of flow. This means that it has a width that is considerably larger than its height. This facilitates installation under a vehicle floor pan, and provides advantages when compared with round cross-sectional shapes that have been commonly used hitherto.

Preferred cross-sections of the filter body are T-shaped, U-shaped or L-shaped cross-sections, as seen in the main direction of flow.

Moreover, one embodiment makes provision that the filter body has a chamber extending through the filter body, with the possibility of extending other vehicular components through such chamber.

The individual bodies preferably have a square cross-section and are extruded bodies made from SiC, as known.

A particular difficulty with producing the device according to the invention, due to the filter body having a cross-section that is at least partially rectangular, is the mounting of the filter body within the housing. The invention makes provision that the filter body is preferably supported in the housing by an axial clamping. This has the following advantage: the angular housing, in contrast to a circular tube, has only a very low bending stability in a lateral or radial direction. In an axial direction, however, the housing is very stable. Due to the axial clamping, the tube is elongated in the axial direction (corresponding to the main direction of flow). Such elongation, however, counteracts a lateral bulging of the tube. Hence, due to the axial clamping the housing will maintain its outer shape in spite of the high clamping force, which is more than 1000 N, preferably about 5000 N.

Consequently the filter body, when the device is at ambient temperature, should be clamped in the housing by an axial force that is larger than a lateral or radial force exerted on the housing.

With a heating of the device during vehicle operation, it is provided according to the invention that the expanding filter body exerts an axial force on the housing that is larger than a lateral or radial force.

The axial force should amount to more than twice, preferably more than ten times the lateral or radial force. In the preferred embodiment there is provided at ambient temperature, an axial surface pressure between the filter body and the housing of 8 N/mm², and a radial surface pressure of only approximately 0.05 N/mm². These extreme differences become even higher during vehicle operation when the filter body is being heated.

The lateral surface pressure compresses a lateral sealing between an outer circumference of the filter body and the housing to a sufficient extent to ensure a sealing effect. Support in the lateral direction occurs indirectly through the axial pressing; low lateral prestressing forces can be neglected here.

At least one sealing body is provided between an outer edge on an end face of the filter body and the housing. Preferably, a sealing body is provided on both end faces. The sealing body transfers the entire axial force between the filter body and the housing. The sealing body usually is resilient, so that stress peaks are avoided and a uniform surface pressure is achieved. Thus, the sealing body has a dual function.

In one example, the sealing body is a sealing ring that extends about the outer circumference adjacent to the end face, and includes at least one sealing portion that extends in front of (outwardly of) the end face. The axial force is then transferred through the sealing portion. In this example, the sealing body has several functions: the sealing body rests at a side of an edge (a transition from the outer circumference to the end face) of the filter body and against the outer circumference thereat. The sealing body seals this location to prevent any leakage flow from escaping from the device in the region of the air gap between the filter body and the housing. Further, the portion at the end face serves for supporting the filter body.

In one example, there is a plurality of sealing portions that are circumferentially spaced apart from each other, and which extend in front of (outwardly of) the end face. If an outer edge on the end face of the filter body is exposed between the sealing portions, then the cross-sectional surface that is covered by the sealing portion at the end face and which decreases the effective cross-sectional area of the filter body, will be considerably reduced altogether.

The sealing body preferably is a knit wire ring provided with a sealing material, or more generally, a metal fiber ring.

A sealing strip, a sealing paste, and/or an insulation mat may be provided between axial ends of the filter body on the outer circumference, if appropriate.

In one embodiment, the invention includes funnel portions at the ends of the housing. The funnel ends are produced by means of folding. In one example, the funnel portions of the housing are manufactured by deep-drawing. There is a limit to deep-drawing, however, particularly in the case of the funnel portions being very long and configured to have an angular shape, like in the present case, and not a conical shape.

These and other features of the present invention can be best understood from the following specification and drawings, the following of which is a brief description.

### BRIEF DESCRIPTION OF THE DRAWINGS

FIG. 1 is a perspective view of a device according to the invention for cleaning vehicle exhaust gas, in this case a filter for diesel exhaust particles.

FIG. 2 is a longitudinal sectional view through the filter for diesel exhaust particles according to FIG. 1.

FIG. 3 is a longitudinal sectional view through the downstream end of the device.

FIG. 4 is a view of an end face of one example of a filter body that can be used with the invention.

FIG. 5 is a view of an end face of one example of a filter body that can be used with the invention.

FIG. 6 is a view of an end face of one example of a filter body that can be used with the invention.

FIG. 7 is a view of an end face of one example of a filter body that can be used with the invention.

FIG. 8 is a view of an end face of one example of a filter body that can be used with the invention.

FIG. 9 is a view of an end face of one example of a filter body that can be used with the invention.

FIG. 10 is a view of an end face of one example of a filter body that can be used with the invention.

FIG. 11 shows a sheet metal blank for manufacturing a funnel portion of the housing of the device according to the invention.

FIG. 12 shows the funnel portion after folding.

### DETAILED DESCRIPTION OF THE PREFERRED EMBODIMENT

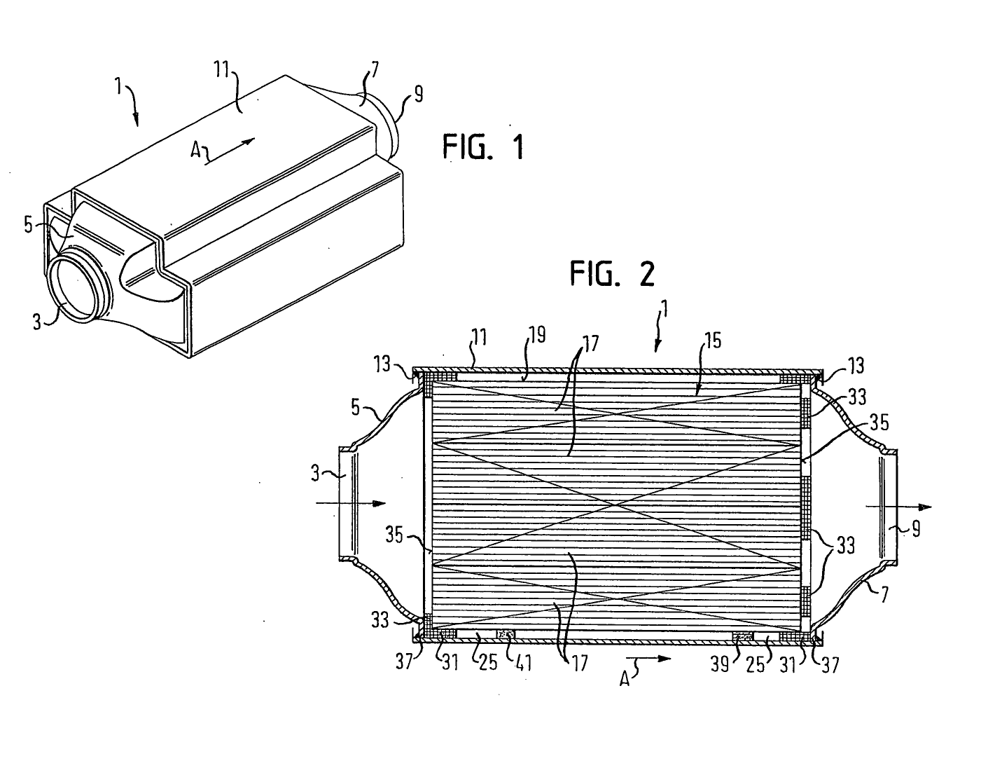

FIG. 1 shows a device for cleaning vehicle exhaust gas, provided in an exhaust tract of a vehicle. The device in the example shown, is a filter for diesel exhaust particles, also called a soot filter, but may also be appropriately configured as a catalytic converter.

The device has an elongated housing 1 composed of several parts. The housing 1 includes one funnel-shaped portion 5 provided with an inflow port 3, and on an opposite end a funnel-shaped portion 7 having an effusion port 9. The housing 1 also includes a peripheral or circumferential wall 11 that is constituted by a deformed tube or formed by folding a sheet of metal. The funnel-shaped portions 5, 7 are welded with the circumferential wall 11, with the two funnel-shaped portions 5, 7 slightly protruding into an interior of the circumferential wall 11 (FIG. 2). Weld seams are referenced by reference symbol 13.

Accommodated in the interior of the housing 1 is a filter body 15 that is composed of a plurality of cuboid, one-piece, individual bodies 17. The individual bodies 17 are in particular extruded substrates made from SiC, whose length is equal to the length of the entire filter body 15 and which have a rod-shaped appearance. The individual bodies 17 in particular have a square cross-section and are glued at side surfaces to adjoining individual bodies 17.

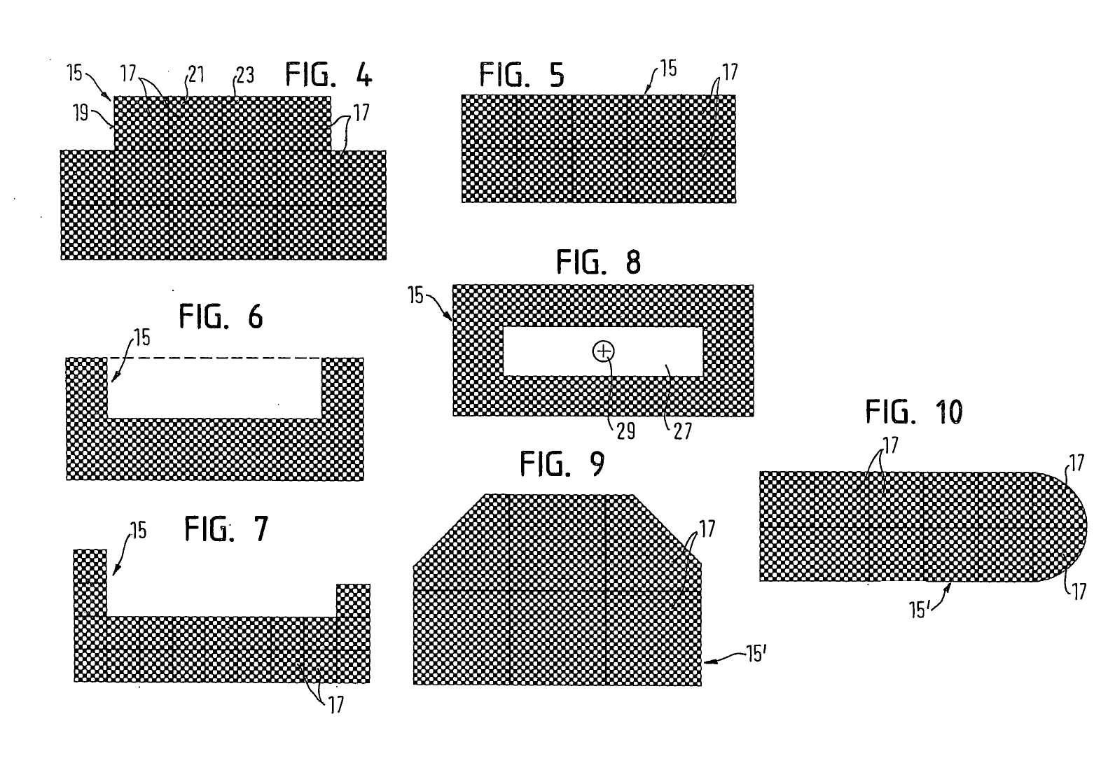

FIG. 4 is a view of an end face of the filter body 15 shown in FIG. 2. As shown, the filter body 15 consists of numerous individual bodies 17 each having a square cross-section, which in a factory-made condition are supplied with an unmachined outer surface. When glued together to form the filter body 15, the outer surface will remain unmachined (no machining or chipping). This means that the entire angular outer contour of the filter body 15 is unmachined along an outer circumference 19.

The individual bodies 17 have numerous inflow channels 21 with a honeycomb-like or square cross-section, which alternate with essentially square walls 23, to provide a kind of honeycomb structure or chessboard pattern. The inflow channels 21 extend deeply into the individual bodies 17 and end therein in each case as a blind hole. Effusion channels protrude from an opposite end face (effusion side) into the walls 23 and end therein likewise as blind holes. Thus, on the opposite side there also arises a view with a similar honeycomb or chessboard pattern, which is just offset with respect to the pattern at the inflow side.

According to FIG. 4 the filter body 15 has a T-shaped cross-section, with the circumferential wall 11 circumscribing this “T”.

The actual flow surface area of the entire filter body 15 is made up of the sum of the actual flow surface areas of the individual bodies 17.

In the embodiments according to FIGS. 5 to 8, each filter body has an overall angular outer contour in a main direction A of flow, i.e. as seen onto the end faces illustrated. Such an outer contour arises by joining the cuboid individual bodies 17 that preferably have a square cross-section. Additionally, the embodiments according to FIGS. 5 to 8 of the filter body provide individual bodies 17 that have an unmachined outer circumference. It is also possible to provide rectangular cross-sections for the individual bodies 17 that could be combined with each other, or combined with individual bodies with square cross-sections.

The embodiment shown in FIG. 5 has a filter body 15 with a rectangular outer contour. The embodiment in FIG. 6 has a filter body 15 with a U-shaped cross-section. The embodiment of FIG. 7 has a U-shaped cross-section with side legs of different heights. The embodiment of FIG. 8 has a rectangular outer circumference and includes a chamber 27 that has a rectangular cross-section extending through the filter body 15. This chamber 27 may serve for accommodating parts such as sensors, which can be used in the device. Optionally, a vehicle component, such as a cardan shaft 29, could extend through the chamber 27.

A filter body 15′ according to FIG. 9 has a trapezoidal cross-sectional area with two external individual bodies 17 that have a beveled outer edge. Apart from these beveled outer edges, the outer contour in the angular portions is unmachined.

In the embodiment according to FIG. 10, the filter body 15′ has two individual bodies 17, shown on the right-hand side, that are rounded by machining. The other individual bodies 17 of the filter body 15′ have an unmachined outer contour. These other individual bodies are unmachined in the region of the angular portion on the left-hand side as shown in FIG. 10, in addition to being unmachined in the region of the upper and lower sides.

All embodiments according to FIGS. 4 to 10 share the common feature that they have a horizontally elongated cross-section, i.e. have a width being larger than the height.

The circumferential wall 11 of the housing 1 surrounds the filter body 15 illustrated in FIG. 4 to provide an air gap 25 with constant width. The air gap 25 is slightly more than 3 millimeters in thickness. The circumferential wall 11 continues along the outer contour of the filter body 15 so as to be evenly spaced apart therefrom by the air gap 25.

The filter body 15 is supported in the housing 1 by an axial clamping in the housing 1. To achieve this, the axial ends of the filter body 15 are provided with a resilient sealing body. The resilient sealing body is provided in the form of a knit wire ring 31 that continuously extends in the circumferential direction, and which is provided with a sealing material. This knit wire ring 31 has an L-shaped form as seen in a longitudinal cross-section, and includes a portion that rests laterally between the outer circumference 19 of the filter body 15 and an inside of the circumferential wall 11. The other leg of the “L” is a sealing portion 33 arranged on an end face 35, and which is clamped between an outer edge of the end face 35 of the filter body 15 and a plane, annular flange portion 37 of the funnel-shaped portions 5, 7. The sealing portion 33 at the end face 35 may surround the end face 35 so as to be radially continuous (see upstream end face).

At the downstream funnel-shaped portion 7 there is a slightly modified variant of the knit wire ring 31. The sealing portions 33 at this end face are provided in segments only, i.e. the segmental end face-sided sealing portions 33 are circumferentially spaced apart from each other, so that between the end face-sided sealing portions 33 the end face of the filter body 15 is completely exposed. With this, the actual flow cross-section of the filter body 15 is reduced by a lesser extent than with a sealing portion, which continuously extends along the circumference of the end face. Of course, the arrangement should be made such that the end faces of the filter body 15 are provided with knit wire rings 31 with a geometrically identical design, i.e. either with an end face-sided sealing portion 33 that continuously extends along the circumference, or with segmental sealing portions 33 that are spaced apart from each other.

As stated, the filter body 15 is arranged in the housing 1 so as to be axially clamped therein by interposition of the sealing portions 33 between the flange portions 37. At ambient temperature the axial prestressing force amounts to approximately 5000 N. This force is so large that there is no requirement for dead stops coming into effect laterally of the outer circumference, which would have the function of preventing the filter body 15 from laterally moving in the housing 1 transversely to the main direction of flow A. It is true that the annular portion of the knit wire ring 31 is disposed laterally between the outer circumference 19 and the circumferential wall 11, but the prestressing forces in the lateral direction are so small (surface pressure about 0.05 N/mm²), that a lateral supporting function can virtually be neglected.

This means that at ambient temperature the axial force or the surface pressure on the end faces 35 is larger than the force or surface pressure acting laterally on the outer circumference 19. The axial force/surface pressure should amount to more than twice, preferably more than ten times, the lateral force/surface pressure.

These values should also be reached when the device is heated up to operating temperature. It is important that under all operating conditions, a sufficient retaining force is available for the filter body 15 through the axial clamping. It could happen, for instance, that with a quick cooling down and a decreasing load, the filter body 15 can contract in a shorter time than the housing 1. Vice versa, the axial pressure on the housing 1 must not become too large when the filter body 15 is heated up quickly. If the filter body 15, during a quick heating, undergoes a larger expansion than the housing 1 so that a tensile stress will be exerted on the housing 1 at a higher operating temperature, then a lateral deformation of the circumferential wall 11 will be counteracted. The resilient knit wire ring 31 acts like a buffer here.

The circumferentially closed portion of the knit wire ring 31, which lies between the circumferential wall 11 and the outer circumference 19, prevents any bypassing exhaust gas flows. If the knit wire ring 31 is not sufficient for this, it is possible to additionally provide, as close as possible to the end faces 35 of the filter body 15, sealing strips 39 or a sealing paste 41, which in each case surround the filter body 15 so as to be circumferentially closed.

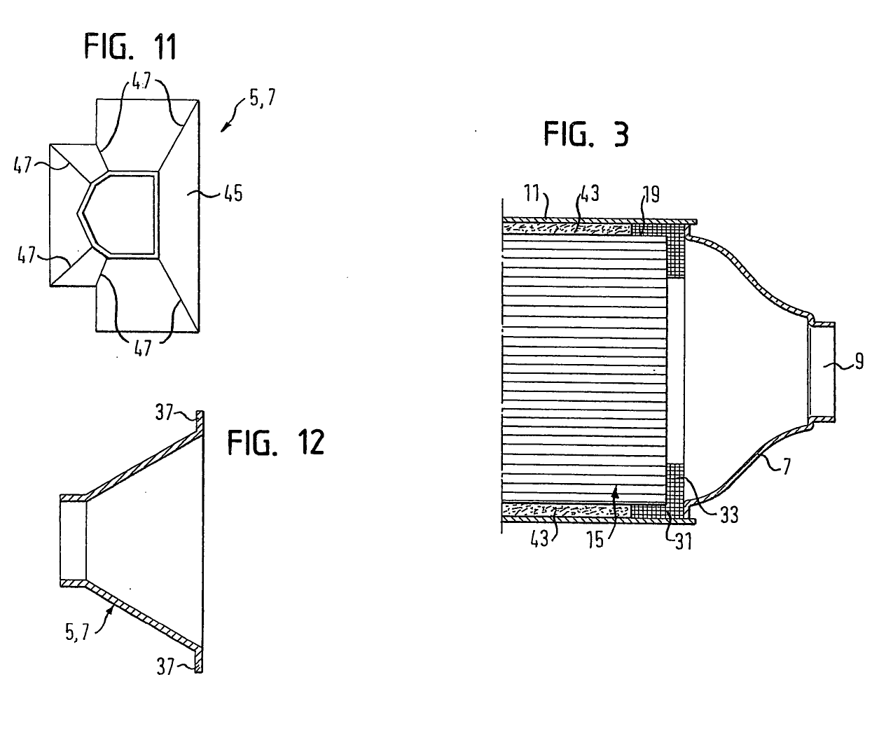

In the embodiment according to FIG. 3, there is provided an insulation mat 43 between the outer circumference 19 and the circumferential wall 11 as well as between the knit wire rings 31 provided on the axial ends. The insulation mat 43 improves the sound dampening. The insulation mat 43 likewise transmits only a very small lateral force on the filter body 15.

During operation of the device, exhaust gas flows through the inflow port 3 in the direction of the arrow into the interior of the housing 1 and spreads out, to penetrate through the inflow channels 21 into the filter body 15. Carbon-like exhaust particles are deposited at the base of the inflow channels 21 that end in the form of blind holes. The exhaust gas flows through the lateral walls delimiting the inflow channels 21, to arrive at the adjoining effusion channels and finally flows out from the device through the effusion port 9.

It is by means of the unmachined, angular shape of the filter body 15 and the support thereof, that a very large active filter surface area arises, i.e. the back pressure level is low and the distribution of the carbon-particulate matter is very uniform. With this, a small cross-sectional area of the filter body 15 will be sufficient, compared with filter bodies that have undergone an extensive machining on their outer surfaces, for filtering the same amount of exhaust gas. Further, it is possible to use a smaller number of expensive one-piece individual bodies 17. The arising uniform charging of the filter body 15 with the carbon-particulate matter results in a uniform combustion behavior with non-critical internal temperatures.

The angular shape of the circumferential wall 11 also requires long, angular funnel-shaped portions 5, 7. The manufacture of the funnel-shaped portions 5, 7 may be done, for instance, by stamping a sheet of metal 45 and subsequent folding (see FIGS. 11, 12). Folding lines are referenced by 47. After folding the funnel-shaped portions 5, 7 are formed, however, edges of the sheet of metal 45 are still open at the circumference along a parting line. The edges of the sheet of metal 45 will be soldered or welded here, until the funnel-shaped portions 5, 7, shown in FIG. 12, are produced in the end.

Although a preferred embodiment of this invention has been disclosed, a worker of ordinary skill in this art would recognize that certain modifications would come within the scope of this invention. For that reason, the following claims should be studied to determine the true scope and content of this invention.

1. A device for cleaning vehicle exhaust gas, in particular a filter for diesel exhaust particulates, comprising:
a filter body through which gas flows in a main direction of flow and which is composed of a plurality of individual cuboid bodies; and
a housing surrounding the filter body wherein the filter body includes at least one angular portion with an angular outer contour along the main direction of flow, and wherein the filter body includes an unmachined outer surface in the at least one angular portion.

2. The device according to claim 1, wherein the housing has an outer contour that generally corresponds in shape to the filter body.

3. The device according to claim 1, wherein the filter body has an overall angular outer contour.

4. The device according to claim 1, wherein the filter body is unmachined across an entire outer circumference.

5. The device according to claim 1, wherein the filter body has an elongated lateral cross-section that extends longitudinally along the main direction of flow.

6. The device according to claim 1, wherein the filter body has one of a T-shaped, U-shaped and L-shaped lateral cross-section that extends longitudinally along the main direction of flow.

7. The device according to claim 1, wherein the filter body includes an inner chamber.

8. The device according to claim 1, wherein the plurality of individual cuboid bodies have a square cross-section.

9. The device according to claim 1, wherein the plurality of individual cuboid bodies are extruded bodies made from silicon carbide (SiC).

10. The device according to claim 1, wherein the filter body is supported in the housing by an axial clamping.

11. The device according to claim 1, wherein at ambient temperature the filter body is clamped in the housing by an axial force that is larger than a lateral force exerted on the filter body.

12. The device according to claim 1, wherein in response to an increase in operational temperature, to a temperature above the ambient temperature, the filter body expands and is mounted in the housing such that an axial force acts on the filter body that is larger than a lateral force exerted on the filter body.

13. The device according to claim 12, wherein at ambient temperature the axial force exerted on the filter body amounts to more than twice the lateral force exerted on the filter body.

14. The device according to claim 1, wherein a lateral sealing is provided between at least a portion of an outer circumference of the unmachined outer surface of the filter body and the housing.

15. The device according to claim 1, wherein at least one sealing body is provided between an outer edge of an end face of the filter body and the housing, wherein the at least one sealing body transfers an entire axial force between the housing and the filter body.

16. The device according to claim 15, wherein the at least one sealing body is a sealing ring extending about at least a portion of an outer circumference of the unmachined outer surface of the filter body adjacent to the end face of the filter body, the sealing ring comprising at least one sealing portion extending laterally outwardly of the end face.

17. The device according to claim 16, including a plurality of sealing portions that are circumferentially spaced apart from each other and extend laterally outwardly of the end face of the filter body, the outer edge on the end face of the filter body being exposed between each of the plurality of sealing portions.

18. The device according to claim 15, wherein the at least one sealing body is a knit wire ring provided with a sealing material.

19. The device according to claim 1, including at least one of a sealing strip, a sealing paste, and an insulation mat between axial ends of the filter body on an outer circumference of the filter body.

20. The device according to claim 1, wherein the housing has axial ends that each include a funnel section where the funnel sections are manufactured by folding.
